(19) United States
(12) Patent Application Publication
(10) Pub. No.: US 2018/0300424 A1
(43) Pub. Date: Oct. 18, 2018

(54) SYSTEMS AND METHODS FOR PROVIDING STRUCTURED MARKUP CONTENT RETRIEVABLE BY A SERVICE THAT PROVIDES RICH SEARCH RESULTS

(71) Applicant: Brewer Digital Marketing, LLC, Louisville, KY (US)

(72) Inventors: Apurva Alok, Goleta, CA (US); Justin Travis DeRosa, Santa Clara, CA (US); Bradley Nolan Brewer, Denver, CO (US); William Henry Brewer, SR., Louisville, KY (US)

(73) Assignee: Brewer Digital Marketing, LLC, Louisville, KY (US)

(21) Appl. No.: 15/487,691

(22) Filed: Apr. 14, 2017

(51) Int. Cl. G06F 17/30

(52) U.S. Cl. CPC G06F 17/30917; G06F 17/30887; G06F 17/30896; G06F 17/30864

(57) ABSTRACT

Systems and methods for providing structured markup content retrievable by a service that provides rich results. An original field module stores original fields and corresponding entries as original field pairs. An ontology mapping module maps the original fields to uniform fields that are compatible with at least one ontology standard. A uniform field module stores the entries and uniform fields that correspond to the entries as uniform field pairs based on the ontology mapping module mapping. A request handling module provides the service with at least one uniform field pair from the uniform field module. A plurality of redirect links are associated with a plurality of accessible sites and are accessible by the service and to direct the service to the request handling module for the request handling module to provide the at least one uniform field pair to the service. The uniform field pairs constitute structured markup content.

### FIELD

The present disclosure generally relates to generating structured markup content retrievable by a service that provides rich search results, and more particularly to mapping original fields to uniform fields to generate structured markup content in accordance with a markup ontology.

### BACKGROUND

The Background and Summary are provided to introduce a foundation and selection of concepts that are further described below in the Detailed Description. The Background and Summary are not intended to identify key or essential features of the claimed subject matter, nor are they intended to be used as an aid in limiting the scope of the claimed subject matter.

In 2011, Google, Bing, and Yahoo introduced the Schema.org initiative, a project geared toward developing a new semantic meta markup ontology for explicitly describing as much of the web as possible to search engines and other web crawlers. When properly implemented, this helps search engines and webcrawlers understand web content more intelligently and to display more relevant search results in more effective ways. The Schema.org coalition was joined by Yandex later in 2011, and since its inception has seen a high adoption rate. Various studies estimate that, as of 2016, over a quarter of the web has adopted the Schema.org markup.

One of the primary reasons for this high adoption rate among web masters and open source CMS developers (such as WordPress and Drupal) is that marked up websites have been afforded increasingly useful and visual distinct displays of their content in search results. This began with “rich snippets,” a variety of visual emphasis to traditional web results, including star ratings with review counts, price ranges, event date and venue information lists and a variety of other relevant at-a-glance details for properly marked up search results. Most recently, “rich cards” have begun to surface in search results, displaying a non-traditional card-style layout of a prominently displayed image at the top with result details underneath.

### SUMMARY

One embodiment of the present disclosure generally relates to systems for providing structured markup content configured to be retrieved by a service that provides rich results. One system has an original field module configured to store original fields and entries that correspond to the original fields as original field pairs. An ontology mapping module is configured to map the original fields to uniform fields and the uniform fields are compatible with at least one ontology standard. A uniform field module is configured to store the entries and uniform fields that correspond to the entries as uniform field pairs and the uniform fields that correspond to the entries are based on the ontology mapping module mapping. A request handling module is configured to provide the service with at least one uniform field pair of the uniform field pairs from the uniform field module. A plurality of redirect links are associated with a plurality of accessible sites and the plurality of redirect links are configured to be accessed by the service and to direct the service to the request handling module for the request handling module to provide the at least one uniform field pair to the service. The uniform field pairs constitute structured markup content that is retrievable by the service to produce rich results.

Another embodiment generally relates to a method for providing structured markup content that is retrievable by a service that provides rich results. The method includes storing original fields and entries that correspond to the original fields as original field pairs, and mapping the original fields and uniform fields by an ontology mapping module. The uniform fields are compatible with at least one ontology standard. The method further includes storing the entries and uniform fields that correspond to the entries as uniform field pairs. The uniform fields that correspond to the entries are based on the ontology mapping module mapping. The method further includes providing a request handling module configured to provide at least one uniform field pair of the uniform field pairs to the service and providing a plurality of redirect links associated with a plurality of accessible sites. The plurality of redirect links are configured to be accessed by the service and to direct the service to the request handling module for the request handling module to provide the at least one uniform field pair to the service. The uniform field pairs constitute structured markup content that is retrievable by the service to produce rich results.

Another embodiment generally relates to systems for providing structured markup content configured to be retrieved by a service that provides rich results. One system includes an original field module configured to store original fields and entries that correspond to the original fields as original field pairs. An ontology mapping module is configured to map the original fields to uniform fields, and the uniform fields are compatible with at least one ontology standard. A uniform field module is configured to store the entries and uniform fields that correspond to the entries as uniform field pairs, and the uniform fields correspond to the entries based on the ontology mapping module mapping. A request handling module is configured to provide the service with at least one uniform field pair of the uniform field pairs from the uniform field module. A plurality of redirect links are associated with a plurality of accessible sites and the plurality of redirect links are configured to be accessed by the service and to direct the service to the request handling module for the request handling module to provide the at least one uniform field pair to the service. A targets of interest module defines a subset of the uniform field pairs that are of interest based on which particular accessible site of the plurality of accessible sites is accessed by the service. The subset of the uniform field pairs is at least one uniform field pair that the request handler provides to the service. The uniform field pairs constitute structured markup content that is retrievable by the service to produce rich results. The ontology mapping module is editable to reflect an updated ontology standard of the at least one ontology standard and when the ontology mapping module is edited to reflect the updated ontology standard, the system is configured to provide structured markup content that is retrievable by the service using the updated ontology standard to produce rich results.

Various other features, objects and advantages of the disclosure will be made apparent from the following description taken together with the drawings.

### BRIEF DESCRIPTION OF THE DRAWINGS

The drawings illustrate the best mode presently contemplated of carrying out the disclosure. The same numbers are used throughout the drawings to reference like features and like components. In the drawings:

FIG. 1 depicts exemplary search results containing both traditional and rich results;

FIG. 2 is a flow chart of an exemplary method in accordance with the present disclosure;

FIG. 3 is a schematic depiction of an exemplary system in accordance with the present disclosure;

FIG. 4 depicts one embodiment for grouping attributes and data sources into objects, and organizing a database of objects and namespace maps; and

FIG. 5 depicts one embodiment of the connection between target URIs and information retrieved from the database.

### DETAILED DISCLOSURE

This written description uses examples to disclose embodiments of the present application, including the best mode, and also to enable any person skilled in the art to practice or make and use the same. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

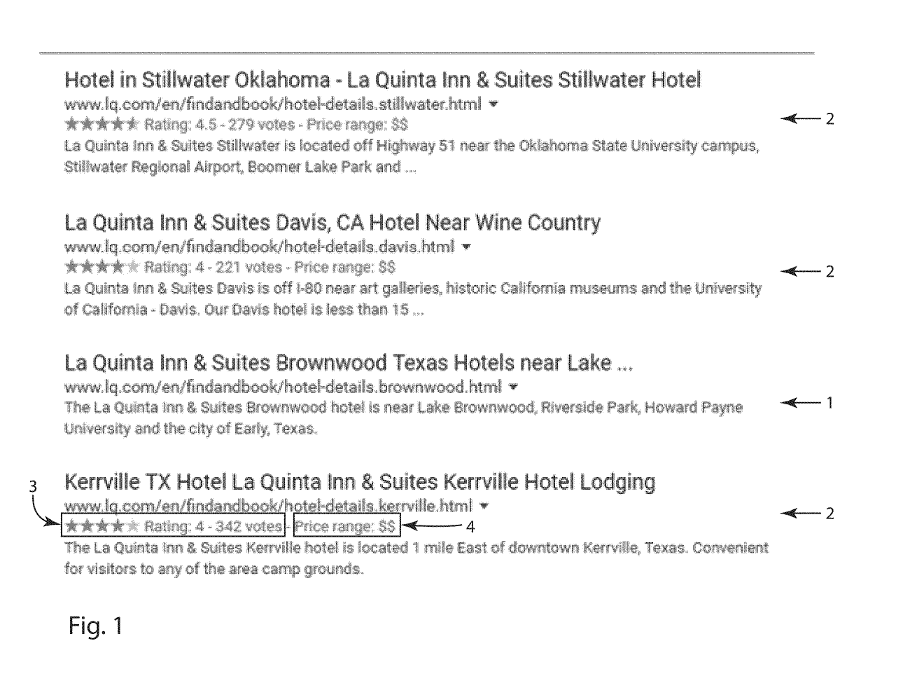

The enhanced results provided by using the Schema.org markup have been found to garner considerably higher click-through-rates than traditional results, also leading to prioritization in search displays over results lacking such semantic markup. An exemplary subset of search results containing both traditional results 1 and rich results 2 is shown in FIG. 1. The rich results 2, which in this case can also be referred to as “rich snippets” also provide the star rating 3 and price range 4 for the hotel location listed in the results. In other examples, including “rich cards”, photos, reviews, and other information may be provided in the rich results.

Accordingly, many webmasters have been eager to revise business and other relevant objects to comport with the necessary markup to obtain these rich results. However, while the markup language itself was designed to be relatively easy to implement, the present inventors have identified that there are still many significant barriers to entry and ongoing difficulties experienced by those trying to employ it.

Specifically, while the Schema.org structure data can be implemented in many formats, webmasters have been overwhelmingly implementing by one of two methods: microdata inserted throughout each of the HTML templates, or JSON-LD as a JavaScript block appended to each webpage. Any given deployment method requires at least some technical knowledge of web development to properly execute, which is a substantial barrier to entry.

Furthermore, the Schema.org ontology convention itself is not always entirely straightforward. Implementing the markup across different web platforms, and sometimes even adding it to existing architectures, often proves a laborious task. Likewise, the markup language often undergoes changes and deprecations, requiring corresponding updates by webmasters to remain current. Similarly, search engines themselves update their requirements for generating rich results, once again requiring existing meta markup to be updated, expanded, or removed by webmasters. However, it is the process of implementing Schema.org at scale that is perhaps the greatest challenge for larger companies seeking to employ structured data. This process typically entails the creation or generation of hundreds (often hundreds of thousands) of script blocks or microdata tags across a website's many pages.

The present disclosure addresses the challenges discussed above, particularly by leveraging JavaScript-based syndication of semantic markup that allows webmasters to insert a single tag to enable URI-specific Schema.org markup across their entire website or web application with little to no technical knowledge of web coding. This JavaScript syndication-based, URI-oriented implementation offers a novel, flexible and scalable approach to appending meta markup to websites. Instead of the traditional method of hand-coding metadata, or even generating it, on a platform-by-platform basis, the present inventors have identified that JavaScript syndication allows for a centralized hub to serve structured markup to a variety of web applications with a minimal amount of overhead. After an initial single setup of mapping data sources to an ontology, and namespace URIs to objects, a single line of code can be employed across a variety of web assets, leveraging real-time third-party code maintenance and updates without the need for changes to the internal architecture.

The indexing of JavaScript syndicated web content in websites and web applications by major search engine was not possible until May 23, 2014, when Google began actively executing JavaScript and applying CSS during its web crawls. Since then, syndicating web content through JavaScript libraries has become a growing industry trend, progressively used to integrate third party services with reduced development complexities and improved software compatibility.

JavaScript files are typically static, stored on server file systems and requiring manual updates. Managing different JavaScript source files on various web applications is difficult to maintain. For this reason, dynamically generated JavaScript files as provided by the present disclosure are a key element of developing a cross-domain, cross-device, and cross-channel data conglomeration web service.

The systems and methods disclosed herein generally relate to extracting contextual data from one or more Universal Resource Identifiers (URIs), API feeds or databases, then mapping these data attributes to semantic ontologies such as the Schema.org ontology. Semantic markup is then generated and served via JavaScript to any requesting party, such as a search engine webcrawler, at scale. In one embodiment, the particular markup served is determined by a dynamically generated namespace map that connects the requesting network location, such as a URL, to its proper semantic markup set, which is discussed further below.

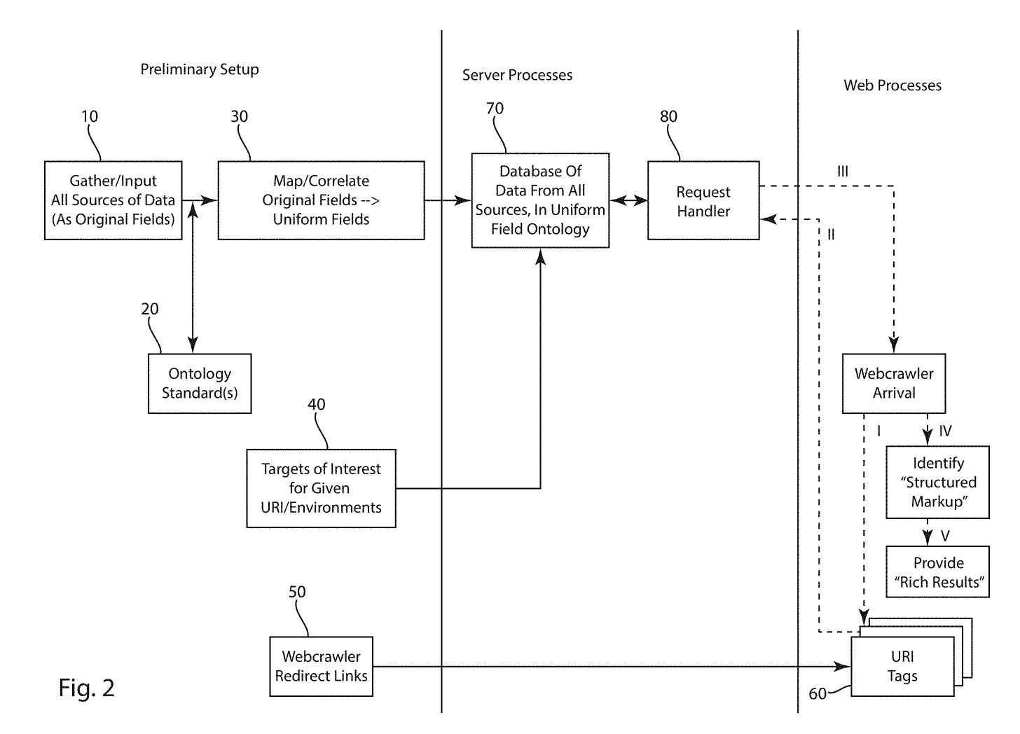

FIG. 2 depicts an exemplary process map in accordance with the present disclosure. In step 10, information is gathered or inputted from all sources of data as original fields and entries. Specifically, this includes business logic and any other sources of information, such as from various URIs, that is stored as an original field and a corresponding entry, together referred to as an original field pair. For example, a field can be “address” and a corresponding entry can be “123 Example Street.” In this manner, step 10 entails gathering all information of interest to be made available to the service for providing rich results, whereby the data is gathered in its original or native form and structure.

In step 20, one or more ontology standards are obtained and stored or otherwise made available. Specifically, these one or more ontology standards include those markups used by services of interest in providing the desired rich results, such as the Schema.org ontology.

In step 30, the original field pairs gathered and stored in step 10 are essentially converted, using the one or more ontology standards from step 20, to map and correlate the original field pairs to uniform field pairs that are compatible with the one or more ontology standards of interest. These mapped uniform field pairs are stored in a database in step 70, whereby the database includes data from all sources, but now with the entries tied to uniform fields to form uniform field pairs in accordance with the one or more ontology standards from step 20.

In certain embodiments, targets of interest for a given URI or environment are also inputted and stored in step 40. Specifically, these targets of interest define a portion of the uniform field pairs to be provided or made available to a service that provides rich results, depending upon the URI or environment accessed by that service. When used, these targets of interest are further incorporated into the structure of the database in step 70.

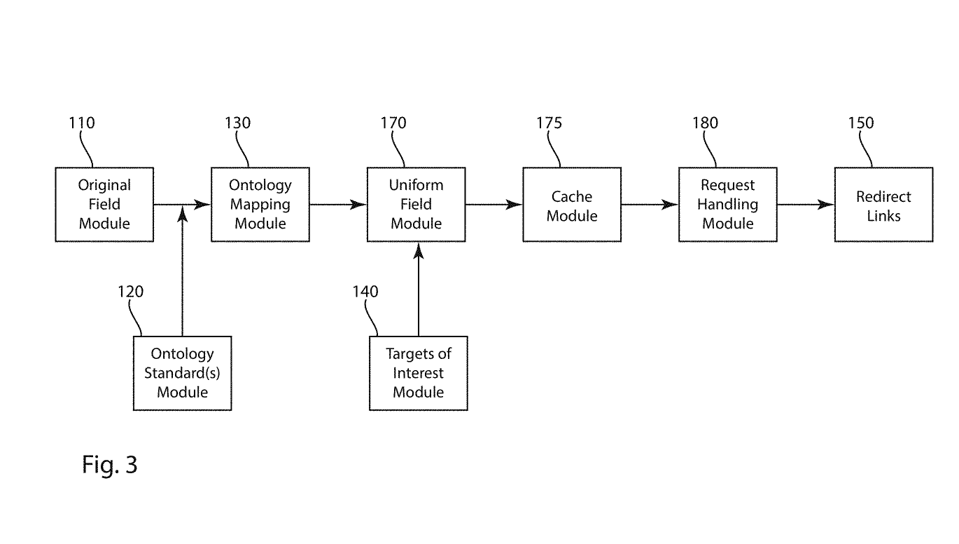

In certain embodiments, the information in the database provided in step 70 is then stored in cache (as discussed later and shown in the FIG. 3). In this case, the cache is provided in communication with a request handler configured to receive requests for data from a service and to provide data to the service from the cache in step 80. In embodiments wherein no separate cache is used, the request handler directly communicates with the database to receive requests from the service and correspondingly provide data to the service at step 80.

In order to direct the service to the request handler for such requests, step 50 includes creating webcrawler redirect links. In one embodiment, these webcrawler redirect links are embedded in URI tags in step 60, wherein the URI tags each correspond to the various URIs that are accessible to the service. These webcrawler redirect links from step 50 direct the service to the request handling module to receive the requests at step 80 and provide corresponding data from stored in step 70 to the service.

As discussed above, in embodiments that include providing a target of interest for given URI or environment at step 40, the request handler provides the corresponding portion of data stored in the database in step 70 to the service in accordance with the provided targets of interest from step 40.

FIG. 2 further shows an exemplary interaction between the presently disclosed process and system and a webcrawler from a service that provides rich results. The embodiment shown in FIG. 2 is configured such that the webcrawler arrives at a URI tag 60 in step I. The URI tag 60, and specifically the webcrawler redirect link from step 50 therein, directs the service at step II to the request handler as discussed above. Depending upon the particular webcrawler redirect link that was accessed by the service, the request handler will provide a corresponding portion of the data from the database back to the web crawler in step III. The data provided to the webcrawler by the request handler at step 80 is provided as “structured markup”, allowing a webcrawler to identify it as such in step IV if the webcrawler uses the one or more ontology standards of the uniform field pairs. Once identified as structured markup, the webcrawler and, more generally the search engine, may then provide “rich results” in step V based on that data.

FIG. 3 depicts one embodiment of a system for providing structured markup content configured to be retrievable by a service that provides rich results. Specifically, FIG. 3 depicts an exemplary system of software and hardware modules configured to implement the exemplary process depicted in FIG. 2. For example, in the embodiment shown, the ontology mapping module 130 of FIG. 3 is configured to map and correlate the original field pairs to uniform field pairs that are compatible with the one or more ontology standards of interest as provided in step 30 of FIG. 2. It should be known that while in the embodiment shown some modules in FIG. 3 directly correlate to a single process depicted in FIG. 2, other embodiments may be considered such that one software or hardware module performs and/or enables multiple process steps, multiple software and/or hardware modules together perform and/or enable a single process step, or any other combinations or divisions of modules to steps.

The system includes an original field module 110 configured to store original fields and entries that correspond to the original fields together as original field pairs. An ontology standard(s) module 120 stores one or more ontology standards that are used by the service of interest, such as the Schema.org ontology standard. An ontology mapping module 130 is configured to map the original fields to uniform fields that are compatible with the at least one ontology standard stored in the ontology standard(s) module 120.

A uniform field module 170 is configured to store the entries from the original field module 110 along with the uniform fields that correspond to these entries together as uniform field pairs. In other words, the uniform fields are essentially translated from the original fields and mapped to correspond to the entries based on this mapping as stored in the ontology mapping module 130.

In certain embodiments, a cache module 175 stores the data from the uniform field module 170 to provide an efficient and expeditious mechanism for sharing this data with a service that provides rich results. However, it should be recognized that a cache module 175 is not required for the presently disclosed system.

A request handling module 180 is provided in communication with the cache module 175 when employed, or directly with the uniform field module 170 when a cache module 175 is not employed. The request handling module 180 is configured to provide the service with at least one of the uniform field pairs from the uniform field module 170 or the cache module 175, as the case may be. One or more webcrawler redirect links 150 associated with a plurality of URI tags (see FIG. 2), associated with “accessible sites”, or URIs that may in theory be accessed by the service, are configured to be accessed by the service. When the service, or its webcrawler, does access such a target site, the webcrawler redirect link 150 directs the service to the request handling module 180 for the request handling module 180 to provide the service with the at least one uniform field pair associated with that accessible site. In this regard, the uniform field pairs constitute “structured markup” content that is retrievable by the service to provide rich results.

In the embodiment shown in FIG. 3, the system further comprises a targets of interest module 140 that defines a subset of uniform field pairs that are of interest based on which particular target site of the plurality of target sites (and corresponding redirect links 150) are accessed by the service. This subset of the uniform field pairs then defines the at least one uniform field pair that the request handling module 180 will provide to the service corresponding to that particular redirect link 150.

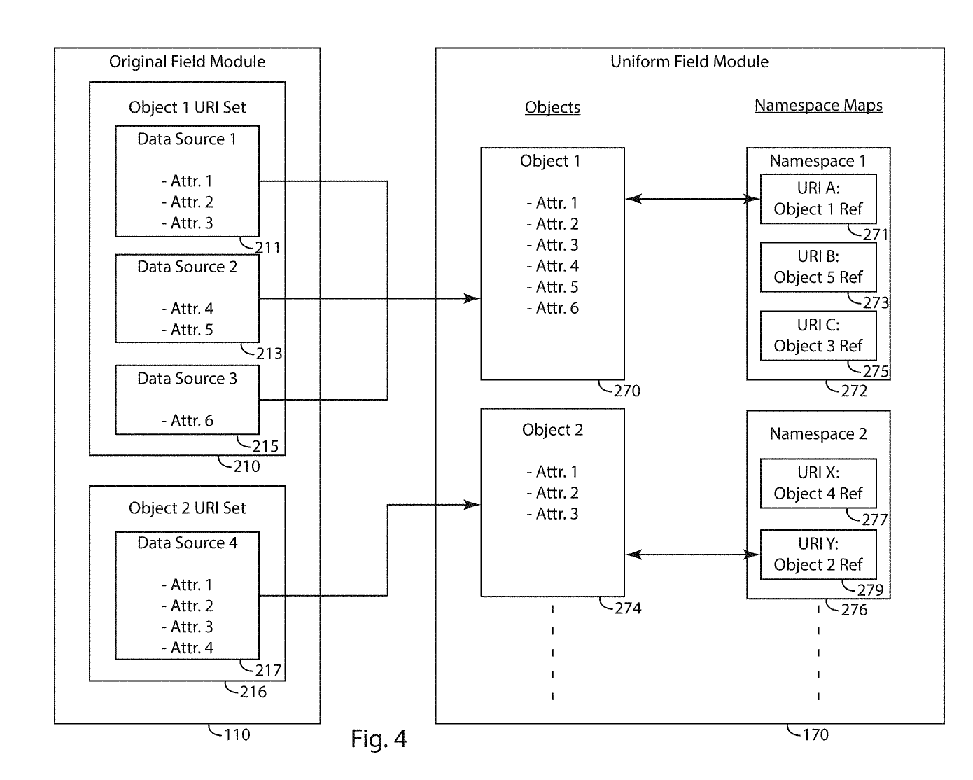

FIG. 4 depicts one exemplary embodiment of the original field module 110 and the uniform field module 170 and how data is stored respectively therein. In the embodiment shown, the original field module 110 stores data gathered from all sources as original fields and as objects based on URI sets. In certain embodiments, these URI sets are groups of accessible sites and the object contains uniform field pairs corresponding to the targets of interest in the targets of interest module 140 for those accessible sites. In the embodiment shown, Object 1 URI Set 210 is configured to store original field pairs in Data Source 1 211, Data Source 2 213, and Data Source 3 215.

In an exemplary case, Object 1 URI Set 210 contains all information relating to a particular location in a hotel chain. Specifically, Data Source 1 211 contains original field pair data taken from the website of the particular location of the hotel chain, Data Source 2 213 contains original field pair data taken from Google® Maps, and Data Source 3 215 contains original field pair data taken from Facebook®—all relating to that particular location of the hotel chain. In this same manner, Object 2 URI Set 216 is configured to store all original field pair data corresponding to a second location of the hotel chain, whereby Data Source 4 217 contains all original field pair data from one source, such as the website for that second location of the hotel chain.

In the embodiment shown, the data stored within Object 1 URI Set 210 in the original field module 110 is then stored as Object 1 270 in the uniform field module 170. In the same regard, all data sources stored under Object 2 URI Set 216 within the original field module 110 are combined and stored as Object 2 274 within uniform field module 170. As described above, the data stored in the uniform field module 170 contains the entries from the original field module 110, but with these entries mapped to uniform fields by the ontology mapping module 130 in accordance with the at least one ontology standard stored in the ontology standard(s) module 120.

FIG. 4 further discloses the inclusion of namespace maps within the uniform field module 170 that pair a particular URI tag, via the webcrawler redirect link 50 therein, with an object within the uniform field module 170 to be provided to the service. Specifically, the uniform field module 170 shown in FIG. 4 includes Namespace 1 272 and Namespace 2 276. Within Namespace 1 272 is URI A: Object 1 Ref 271, URI B: Object 5 Ref 273, and URI C: Object 3 Ref 275, which each represent a particular URI that is accessible to the service.

Using the previous example of a hotel chain, URI A represents the overall hotel chain website, URI B represents the website of a particular location of the hotel chain, and URI C represents a mobile app for the hotel chain. In the embodiment shown in FIG. 4, URI A: Object 1 Ref 271 is linked to Object 1 270, which as previously stated is a stored combination of the uniform field pairs from Data Source 1 211, Data Source 2 213, and Data Source 3 215 from the original field module 110 stored within the Object 1 URI Set 210 therein. In this regard, a service or a webcrawler accessing URI A is ultimately provided with the uniform filed pairs from Object 1 270 according to the processes previously discussed.

Similarly, the uniform field module 170 shown in FIG. 4 includes Namespace 2 276, which includes URI X: Object 4 Ref 277 and URI Y: Object 2 Ref 279. In this example, URI Y: Object 2 Ref 279 would redirect a service accessing it to Object 2 274 within the uniform field module 170, which as previously discussed contains a combination of data from the Object 2 URI set 216 in the original field module 110, converted to uniform field pairs.

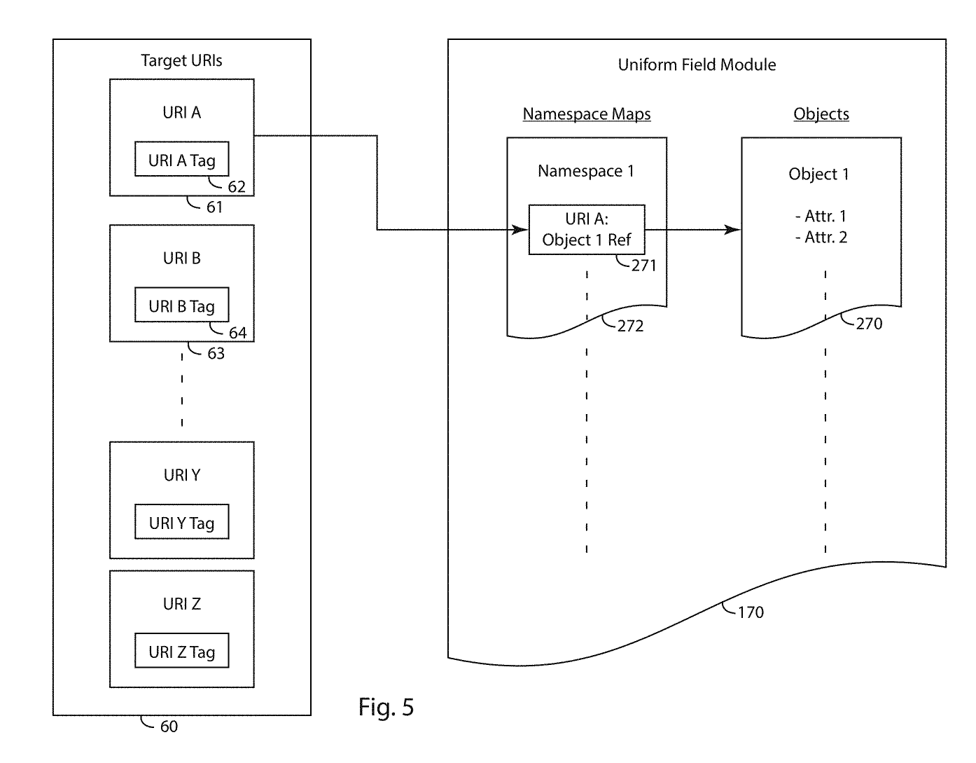

FIG. 5 further demonstrates the process by which the service is directed to the uniform field module 170 (by way of the request handling module 180, as previously discussed). In the exemplary configuration shown, a series of URI Tags from step 60 (target sites) are accessible to the service. These include URI A 61 and URI B 63, containing URI A tag 62 and URI B tag 64, respectively. As previously discussed, the URI A tag 62 would contain a corresponding webcrawler redirect link 50 to direct the service to the uniform field module 170 via the request handling module 180 (not expressly shown). In this example, URI A tag 62 directs the service to the URI A: Object 1 Ref 271 within Namespace 1 272 in uniform field module 170. URI A: Object 1 Ref 271 is further linked to Object 1 270 within uniform field module 170, as previously discussed. Therefore, a service accessing URI A 61 is directed by URI A tag 62, and the webcrawler redirect link 50 therein, to the request handling module 180 and is ultimately provided with data from to Object 1 270 within uniform field module 170 to the service.

It should be noted that components of the embodiments presently disclosed may be combined, removed, or added to while retaining the intended function of providing structured markup content that can be identified by a service using an ontology standard to generate rich results.

It should be apparent that the presently disclosed systems and methods provide substantial benefits over those presently known in the art. Among these is that after the initial data architecture setup, consumers can implement Schema.org and other structured markup formats across a variety of web platforms and across thousands to hundreds of thousands of pages by inserting a single JavaScript tag. For many websites, this involves saving the code snippet in a single location one time, instantly enabling semantic markup on all pages. The code can also be inserted through existing tag management services, enabling the implementation of powerful structured data markup without the need for advanced technical knowledge.

Compared to the known prior art, the presently disclosed systems and methods completely decouples the requesting URIs from the sources of the metadata output granted to the URIs. This allows for a considerably greater level of flexibility in JavaScript syndication. The presently disclosed systems and methods are configured to employ multiple data sources, which may or may not originate from the system users themselves, to inform the meta markup appended into a variety of platforms across the web. In this regard, completely isolated API feeds, databases, and even static data files can be used to inform the structured data points associated with any given markup-requesting URI.

Furthermore, since the systems and methods described herein can be hosted on third-party cloud computing services, as well as being maintained by structured data specialists, users can be assured of maximum availability and up-to-the-minute currency and accuracy of their markup implementation. The moment a new structured markup ontology update is available, a single code change by the third-party host can immediately go live for thousands or tens of thousands of websites, across hundreds of thousands or even millions of individual pages. This immediately saves participating webmasters countless hours of unnecessary code reworking.

In the above description, certain terms have been used for brevity, clarity, and understanding. No unnecessary limitations are to be inferred therefrom beyond the requirement of the prior art because such terms are used for descriptive purposes and are intended to be broadly construed. The different assemblies described herein may be used alone or in combination with other devices. It is to be expected that various equivalents, alternatives and modifications are possible within the scope of any appended claims.

We claim:

1. A system for providing structured markup content configured to be retrieved by a service that provides rich results, the system comprising:
an original field module configured to store original fields and entries that correspond to the original fields as original field pairs;
an ontology mapping module configured to map the original fields to uniform fields, wherein the uniform fields are compatible with at least one ontology standard;
a uniform field module configured to store the entries and uniform fields that correspond to the entries as uniform field pairs, wherein the uniform fields that correspond to the entries are based on the ontology mapping module mapping;
a request handling module configured to provide the service with at least one uniform field pair of the uniform field pairs from the uniform field module; and
a plurality of redirect links associated with a plurality of accessible sites, the plurality of redirect links being configured to be accessed by the service and to direct the service to the request handling module for the request handling module to provide the at least one uniform field pair to the service;
wherein the uniform field pairs constitute structured markup content that is retrievable by the service to produce rich results.

2. The system according to claim 1, further comprising a targets of interest module, wherein the targets of interest module defines a subset of the uniform field pairs that are of interest based on which particular accessible site of the plurality of accessible sites is accessed by the service, and wherein the subset of the uniform field pairs is the at least one uniform field pair that the request handler provides to the service.

3. The system according to claim 2, wherein the particular accessible site is a Universal Resource Identifier associated with a mobile version of a website.

4. The system according to claim 1, wherein an additional ontology standard is addable to the at least one ontology standard mapped by the ontology mapping module to provide structured markup content that is retrievable by the service using the additional ontology standard to produce rich results.

5. The system according to claim 1, wherein the ontology mapping module is editable to reflect an updated ontology standard of the at least one ontology standard, wherein when the ontology mapping module is edited to reflect the updated ontology standard, the system is configured to provide structured markup content that is retrievable by the service using the updated ontology standard to produce rich results.

6. The system according to claim 5, wherein when the ontology mapping module is edited to reflect the updated ontology standard, the plurality of redirect links are updated to reflect the updated ontology standard.

7. The system according to claim 1, wherein the original field pairs originate from multiple sources.

8. The system according to claim 7, wherein the multiple sources include an API feed.

9. The system according to claim 1, wherein the at least one ontology standard includes the schema.org standard.

10. The system according to claim 1, wherein the plurality of redirect links include JavaScript tags.

11. The system according to claim 1, wherein the original field module periodically updates the original field pairs.

12. A method for providing structured markup content that is retrievable by a service that provides rich results, the method comprising:
storing original fields and entries that correspond to the original fields as original field pairs;
mapping the original fields and uniform fields by an ontology mapping module, wherein the uniform fields are compatible with at least one ontology standard;
storing the entries and uniform fields that correspond to the entries as uniform field pairs, wherein the uniform fields that correspond to the entries are based on the ontology mapping module mapping;
providing a request handling module configured to provide at least one uniform field pair of the uniform field pairs to the service; and
providing a plurality of redirect links associated with a plurality of accessible sites, the plurality of redirect links being configured to be accessed by the service and to direct the service to the request handling module for the request handling module to provide the at least one uniform field pair to the service;
wherein the uniform field pairs constitute structured markup content that is retrievable by the service to produce rich results.

13. The method according to claim 12, further comprising providing a targets of interest module that defines a subset of the uniform field pairs that are of interest based on which particular accessible site of the plurality of accessible sites is accessed by the service, and wherein the subset of the uniform field pairs is the at least one uniform pair that the request handler provides to the service.

14. The method according to claim 12, further comprising adding an additional ontology standard to the at least one ontology standard mapped by the ontology mapping module to provide structured markup content that is retrievable by the service using the additional ontology standard to produce rich results.

15. The method according to claim 12, wherein the ontology mapping module is editable to reflect an updated ontology standard of the at least one ontology standard, wherein when the ontology mapping module is edited to reflect the updated ontology standard, the system is configured to provide structured markup content that is retrievable by the service using the updated ontology standard to produce rich results.

16. The method according to claim 12, wherein the original field pairs originate from multiple sources, and wherein the multiple sources include an API feed.

17. The method according to claim 12, wherein the at least one ontology standard includes the schema.org standard.

18. The method according to claim 12, wherein the plurality of redirect links include JavaScript tags.

19. The method according to claim 12, further comprising periodically updating the original field pairs.

20. A system for providing structured markup content configured to be retrieved by a service that provides rich results, the system comprising:
an original field module configured to store original fields and entries that correspond to the original fields as original field pairs;
an ontology mapping module configured to map the original fields to uniform fields, wherein the uniform fields are compatible with at least one ontology standard;
a uniform field module configured to store the entries and uniform fields that correspond to the entries as uniform field pairs, wherein the uniform fields that correspond to the entries are based on the ontology mapping module mapping;
a request handling module configured to provide the service with at least one uniform field pair of the uniform field pairs from the uniform field module; and
a plurality of redirect links associated with a plurality of accessible sites, the plurality of redirect links being configured to be accessed by the service and to direct the service to the request handling module for the request handling module to provide the at least one uniform field pair to the service;
a targets of interest module, wherein the targets of interest module defines a subset of the uniform field pairs that are of interest based on which particular accessible site of the plurality of accessible sites is accessed by the service, and wherein the subset of the uniform field pairs is the at least one uniform field pair that the request handler provides to the service;
wherein the uniform field pairs constitute structured markup content that is retrievable by the service to produce rich results; and
wherein the ontology mapping module is editable to reflect an updated ontology standard of the at least one ontology standard, wherein when the ontology mapping module is edited to reflect the updated ontology standard, the system is configured to provide structured markup content that is retrievable by the service using the updated ontology standard to produce rich results.
